(19) United States
(12) Patent Application Publication
(10) Pub. No.: US 2012/0041772 A1
(43) Pub. Date: Feb. 16, 2012

(54) SYSTEM AND METHOD FOR PREDICTING LONG-TERM PATIENT OUTCOME

(75) Inventors: Shahram Ebadollahi, TARRYTOWN, NY (US); Jianying Hu, BRONX, NY (US); Robert K. Sorrentino, RANCHO PALOS VERDES, CA (US); Daby M. Sow, CROTON ON HUDSON, NY (US); Jimeng Sun, WHITE PLAINS, NY (US)

(73) Assignee: INTERNATIONAL BUSINESS MACHINES CORPORATION, ARMONK, NY (US)

(21) Appl. No.: 12/855,060

(22) Filed: Aug. 12, 2010

(51) Int. Cl. G06Q 50/00

(52) U.S. Cl. 705/2

(57) ABSTRACT

A system and method for predicting patient prognosis includes a similarity module configured in program storage media to provide a similarity function for a data source and compute similarity scores for pairs of patients. An alignment module is configured to align a query patient to a best anchor timestamp of a similar patient or patients so that a comparison between the query patient and at least one similar patient is provided. A prediction module is configured to predict a long-term outcome measure of the query patient based on data from the at least one similar patient.

### CROSS-REFERENCE TO RELATED APPLICATIONS

This application is related to commonly assigned U.S. application Ser. No. [TBD], entitled “SYSTEM AND METHOD FOR PREDICTING NEAR-TERM PATIENT TRAJECTORIES”, Attorney Docket Number YOR920100440US1 (163-358), filed concurrently herewith, which is incorporated by reference herein in its entirety.

### BACKGROUND

1. Technical Field

The present invention relates to medical prognosis tools and more particularly to systems and methods for predicting long term prognosis of patients using similarity models and other tools.

2. Description of the Related Art

Prognosis is a component of the process of clinical care. Prognosis is a task that predicts a future health status of a patient and a probable course of his/her health indicators. Long term prognosis is often quantified in terms of a number of associated outcome measures such as health status, lab results and cost. Accurately predicting outcome measures of individual patients improves the effectiveness and efficiency of healthcare systems. Usually, a long-term prognosis is done on a population level rather than the individual patient level.

Near term prognosis is different from long term prognosis. The time scale is different between the two. Near twin prognosis is mostly related to intensive care unit (ICU) settings, while long term prognosis covers broader domains. Near term prognosis focuses directly on monitoring and predicting the physiological time series, while long term prognosis focuses on future health status of the patient.

### SUMMARY

A system and method for predicting patient prognosis includes a similarity module configured in program storage media to provide a similarity function for a data source and compute similarity scores for pairs of patients. An alignment module is configured to align a query patient to a best anchor timestamp of a similar patient or patients so that a comparison between the query patient and at least one similar patient is provided. A prediction module is configured to predict a long-term outcome measure of the query patient based on data from the at least one similar patient.

A method for long term patient prognosis includes constructing similarity functions from a plurality of data sources stored in physical memory; combining similarity scores into an overall similarity score between patients; aligning at least one similar patient based on a time dimension; and predicting an outcome measure of a query patient based on the at least one similar patient.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram showing a system/method for long term patient prognosis in accordance with one illustrative embodiment;

FIG. 2 is a block/flow diagram showing a similarity module in further detail in accordance with one illustrative embodiment;

FIG. 3 is a block/flow diagram showing an alignment module in further detail in accordance with one illustrative embodiment;

FIG. 4 is a block/flow diagram showing a prediction module in further detail in accordance with one illustrative embodiment; and

FIG. 5 is a block/flow diagram showing a system/method for long term patient prognosis in accordance with another illustrative embodiment.

### DETAILED DESCRIPTION OF PREFERRED EMBODIMENTS

In accordance with the present principles, systems and methods are provided to predict long term prognosis of patients. Long term prognosis in accordance with the present principals includes predicting a set of outcome measures based on similar cases or conditions. The long term prognosis systems and methods can be configured to handle many what-if scenarios that can lead to different expected outcomes. No known method or system has attempted to predict long term trajectories for a query patient using historical data or patterns from similar patients. Historical data from similar patients can help provide better estimates of what is going to happen to a query patient, and what the different treatment options could be and what their expected outcomes might be.

In one embodiment, a general patient similarity measure handles heterogeneous and longitudinal patient records; a temporal alignment method compares patients at different stages of disease progression and a predictive model of a query patient is based on similar patient's characteristics.

A system/method may include a similarity module which integrates heterogeneous sources of patient information and computes a similarity between patients. An alignment module finds the best longitudinal alignment of similar patients, and a predictive model leverages information from the aligned similar patients to build a model for predicting the query patient. A model analyzer permits what-if types of analyses to test different treatment options.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

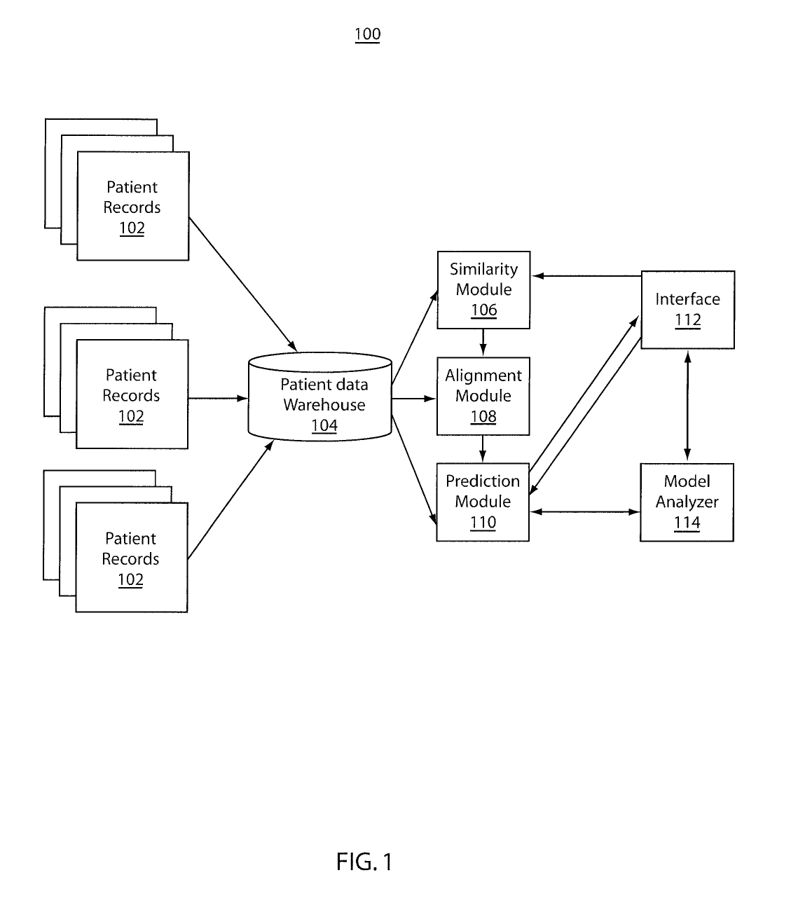

Referring now to the drawings in which like numerals represent the same or similar elements and initially to FIG. 1, a system/method 100 for predicting long term prognosis of patients is illustratively shown in accordance with one embodiment. System 100 may include on a single processing device such as a computer, a personal digital assistant or other computing device, or may include a plurality of distributed computers in a network environment or the like.

Patient records 102 may be employed to create a patient data warehouse 104. Patent records 102 may include digital documents, charts, physical records, or any other means for storing medical information for patients. The patient records 102 are integrated into the data warehouse 104 such that the information is structured and searchable for compiling statistics, patient information, etc. The patient data warehouse 104 may include entries from a plurality of heterogeneous external data sources. The patient warehouse 104 may transform information into a consistent representation of patient records or may categorize records into a plurality of data sources.

A similarity module 106 constructs customizable patient similarity measures which are applied to the patient data to find similar patients for each query patient. The similarity module 106 configures a highly customizable similarity measure based on the data and physician feedback from an interface 112 and computes the similarity scores between any pair of patients. The similarity module 106 retrieves top-k similar patients given the query patient. Similarity measures may be derived for particular medical condition, patient demographics, diseases, treatment program or any other criteria. A number of best matches (k) may be selected by the user and may be adjusted depending on the output desired.

An alignment module 108 compares a pair of similar patients and identifies a longitudinal offset to align pairs of patients. The patient records may include a multi-dimensional vector and such comparisons may include vector differences or correlations between patient records. The longitudinal offset is an alignment difference or distance between the two cases. The alignment aims at providing a more meaningful comparison of patients, e.g., in different stages of a disease progression, in different age groups, in different demographics, etc. Alignment can also provide reference points for the query patient who is at earlier stage of the disease progression by using the actual data from another patient. The field of similar patients may use multiple user records to predict a single query patient based on a best match for a present set of conditions.

A prediction module 110 forecasts various outcome measures of a given query patient. Outcome measures may include any parameter, but may include e.g., health status, lab results, cost, life expectancy, recovery time, disease progression, etc. The prediction model 110 is built based on similar patients and their outcome measures. A physician or other technician can further select a potential treatment plan, and the prediction model 110 may provide an expected outcome using that treatment plan based on the historical data of the similar patients. Multiple expected outcomes may also be provided. These outcomes may include percentages or probabilities to permit a most likely prediction for the patient under the present conditions. The predictive model 110 may also be employed to provide what-if scenarios which permit changing of selected data to reconstruct a model for predicting a prognosis for the query patient or for any set of conditions. A model analyzer 114 permits a what-if type of analysis to test different treatment options. A user may create a patient model and submit the model as a query patient.

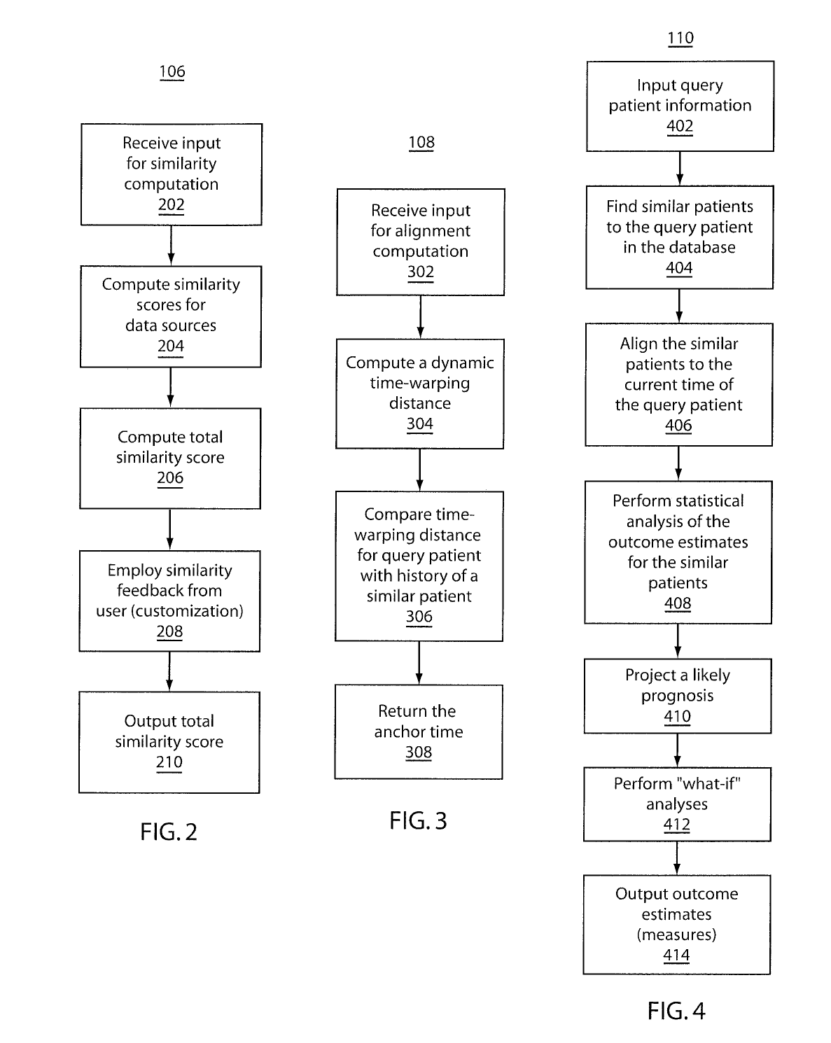

Referring to FIG. 2, the similarity module 106 is described in further detail. The similarity module 106 computes a similarity measure or measures. In block 202, a similarity computation includes as input, e.g., patients x and y from multiple data sources D₁, D₂, . . . , Dₙ), and corresponding weights w₁, w₂, . . . , wₙ. where wᵢ is an importance weighting coefficient for similarity of data source Dᵢ. In block 204, similarity scores s₁, s₂, . . . , sₙ of x and y are computed on each data source (Dᵢ). In block 206, a total score is combined as s=w₁*s₁+w₂*s₂+ . . . +wₙ*sₙ. In block 208, similarity feedback is employed. This feedback may include customization of data sources (e.g., including or excluding data sources), varying weights, etc. In particular, weighting coefficient wᵢ can be increase or decrease based on the user input to adjust the importance of a given data source. Based on characteristics of different data sources, we apply different similarity functions to compute the similarity scores on each data source, e.g., categorical similarity, numeric similarity, temporal similarity (dynamic time-warping distance), etc. An output includes a total score s in block 210.

Patient similarity measures may be determined in a plurality of ways. In one particularly useful embodiment, similarity measures may be determined using localized supervised metric learning (LSML) to provide a patient similarity measure. When a physician looks for similar patients in a database, the similarity is often based not only on quantitative measurements such as lab results, sensor measurements, age and sex, but also on the physician's assessment of the disease type and stage. The assessment would potentially influence the relative importance a physician places on different measurements or groups of measurements. To compute this specific notion of similarity, a distance metric is needed that can automatically adjust the importance of each numeric feature by leveraging the physician's belief.

Formally, quantitative measurements of a patient are represented by an N-dimensional feature vector x. Examples of features are the mean and variance of the sensor measures, or Wavelet coefficients. The prior belief of physicians is captured as labels on some of the patients. With this formulation, one goal is to learn a generalized Mahalanobis distance between patient xᵢ and patient xⱼ defined as:

dₘ(xᵢ,xⱼ)=\sqrt{(xᵢ−xⱼ)^{T}P(xᵢ−xⱼ)} (1)

where Pε [symbol] ^{N×N} is called the precision matrix. Matrix P is positive semi-definite and is used to incorporate the correlations between different feature dimensions. One aspect is to learn the optimal P such that the resulting distance metric has the following properties: 1) Within-class compactness: patients of the same label are close together; and 2) Between-class scatterness: patients of different labels are far away from each other. To formally measure these properties, we use two kinds of neighborhoods: 1) The homogeneous neighborhood of xᵢ, denoted as [symbol] ᵢ^{o}, is the k-nearest patients of xᵢ with the same label. 2) The heterogeneous neighborhood of xᵢ, denoted as [symbol] ᵢ^{e}, is the k-nearest patients of xᵢ with different labels.

Based on these two neighborhoods, we define the local compactness of point xᵢ as

$${C}_{i} = {\sum }_{{x}_{j} ∈ {𝒩}_{i}^{o}} {d}_{m}^{2} ( {x}_{i} , {x}_{j} ) \qquad ( 2 )$$

and the local scatterness of point xᵢ as

$${S}_{i} = {\sum }_{{x}_{k} ∈ {𝒩}_{i}^{e}} {d}_{m}^{2} ( {x}_{i} , {x}_{k} ) \qquad ( 3 )$$

The discriminability of the distance metric dₘ is defined as

$$𝒥 = \frac{{\sum }_{i} {C}_{i}}{{\sum }_{i} {S}_{i}} = \frac{{\sum }_{i} {\sum }_{{x}_{j} ∈ {𝒩}_{i}^{o}} {( {x}_{i} - {x}_{j} )}^{T} P ( {x}_{i} - {x}_{j} )}{{\sum }_{i} {\sum }_{{x}_{k} ∈ {𝒩}_{i}^{e}} {( {x}_{i} - {x}_{k} )}^{T} P ( {x}_{i} - {x}_{k} )} \qquad ( 4 )$$

The goal is to find a P that minimizes [symbol] , which is equivalent to minimizing the local compactness and maximizing the local scatterness simultaneously. In contrast with linear discriminant analysis, which seeks a discriminant subspace in a global sense, the localized supervised metric aims to learn a distance metric with enhanced local discriminability. To minimize [symbol] , we formulate the problem as a trace ratio minimization problem and use the decomposed Newton's method to find the solution.

Since P is a low-rank positive semi-definite matrix, we can decompose the precision matrix as P=WW^{T}, where Wε [symbol] ^{N×d} and d≦N. The distance metric can be rewritten as dₘ(xᵢ,x)=∥W^{T}xᵢ−W^{T}xⱼ∥. Therefore, the distance metric is equivalent to Euclidean distance over the low-dimensional projection W^{T}x.

Referring to FIG. 3, the alignment module 108 is described in greater detail. In one embodiment, alignment module 108 performs a longitudinal alignment. In block 302, the input information may include recent longitudinal events W which is a set of time series events from a query patient x, an entire history H of patient y, which is another set of time series events from patient y. There are corresponding types of events in both W and H, but the length of W is usually smaller than H. For every potential anchor time t in y, compute a dynamic time-warping distance or Euclidean distance d from W to H(t) in block 304. H(t) is the history of patient y up to time t. If the minimum distance>d then the minimum distance=d and anchor time=t in block 306. In block 308, the anchor time is returned. The anchor timestamp in y matches the current time of x (longitudinal alignment). The intuition of longitudinal alignment is to try to best match the query patient's current events to the other historical patient in time, so that we can compare two patients who are in different stages of the disease.

Referring to FIG. 4, the prediction module 110 is described in greater detail. The prediction module 110 preferably makes predictions based on existing data from other patients. In block 402, a query patient, x, has his information input. In block 404, similar patients to x are found from a database. In block 406, the similar patients are aligned to the current time of x. In block 408, a statistical average of the outcome estimates of those similar patients is performed. The prediction module 110 predicts clinical pathways into different time intervals to project a likely prognosis for patient x in block 410. In block 412, what-if analyses may be performed. This may include taking a treatment plan and query patient information as input, and then predicting the expected outcomes of this particular treatment on the query patient. The treatment parameters may be adjusted; the patient information may be adjusted; other parameters may be adjusted; etc. to run other scenarios. In block 414, outcome estimates at the present time or over time may be output. Here, the outcome estimates are derived from the actual outcome measures from similar patients. For example, we can use a mean or median of the outcome measures from the similar patients, or other statistics models such as, regression, which uses the outcome measures from similar patients.

To illustrate through a specific example, given a patient X, a 52 year old male who has diabetes without any complications. The system can compute similarity scores to other patients in the data warehouse (104) from diagnosis information such as ICD9 codes, procedure information such as CPT codes, medication information such as NDC codes, lab test results, and demographic information. The similarity scores on all data sources are combined through the weighting coefficients to obtain a global score. The doctor might decide to increase the weight for diagnosis similarity score and reduce the weight on procedure scores based on the characteristics of the patient. The set of similar patients are retrieved. Then, the doctor looks at what treatments have been done on the similar patients who had a good or positive outcome and decides to select the corresponding treatment for patient X.

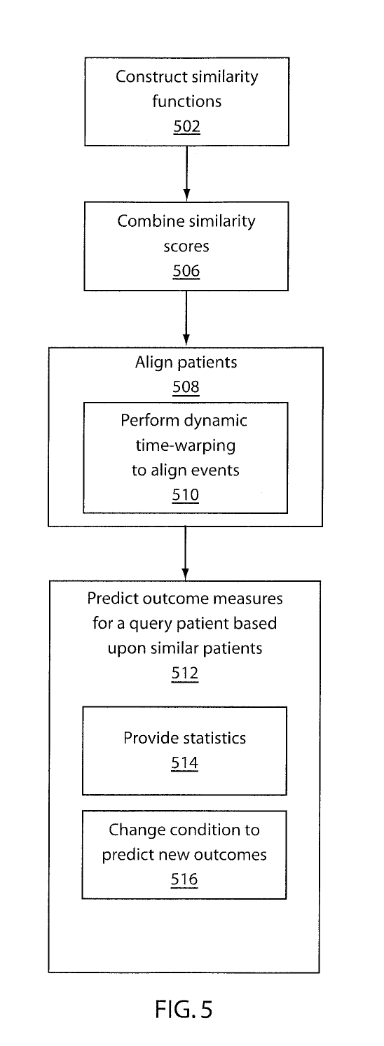

Referring to FIG. 5, a long term patient prognosis system and method is illustratively depicted. In block 502, similarity functions are constructed from a plurality of data sources stored in physical memory. The data sources may include different reports, different tests, different studies, etc. In block 506, similarity scores are combined into an overall similarity score between patients. In block 508, similar patients are aligned based on a time dimension. In block 510, a dynamic time-warping distance may be computed from an event in a timeline of a query patient to a history of a similar patient to provide a longitudinal alignment.

In block 512, an outcome measure of a query patient is predicted based on the similar patients. Predicting an outcome measure may include predicting a progression of a disease, predicting a life expectancy, predicting a patient recovery time, etc. In block 514, statistical probabilities of a plurality of outcomes may be provided based upon similar patient models. In block 516, predicting the outcome measure may include predicting a new outcome measure by changing conditions used to predict the outcome measure.

Having described preferred embodiments of a system and method for predicting long-term patient outcome (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A system for predicting patient prognosis, comprising:
a database having stored patient data;
a similarity module configured in program storage media to provide a similarity function for a data source and compute similarity scores for pairs of patients;
an alignment module configured to align a query patient to a best anchor timestamp of a similar patient or patients so that a comparison between the query patient and at least one similar patient is provided; and
a prediction module configured to predict a long-term outcome measure of the query patient based on data from the at least one similar patient.

2. The system as recited in claim 1, wherein the data from the at least one similar patient includes historical patient data.

3. The system as recited in claim 1, wherein the data from the at least one similar patient includes statistical averages of patient data.

4. The system as recited in claim 1, further comprising a model analyzer configured to permit a user to adjust an input to test the long-term outcome measure.

5. The system as recited in claim 1, further comprising an interface configured to permit user customization of the similarity module.

6. The system as recited in claim 5, wherein user customization includes at least one of changing weights of similarity score, changing a set of data sources and changing the similarity function.

7. The system as recited in claim 1, wherein the alignment module performs a longitudinal alignment between the query patient and patients stored in the database.

8. A method for long term patient prognosis, comprising:
constructing similarity functions from a plurality of data sources stored in physical memory;
combining similarity scores into an overall similarity score between patients;
aligning at least one similar patient based on a time dimension; and
predicting an outcome measure of a query patient based on the at least one similar patient.

9. The method as recited in claim 8, wherein predicting the outcome measure includes predicting a new outcome measure by changing conditions used to predict the outcome measure.

10. The method as recited in claim 8, wherein predicting an outcome measure includes predicting a progression of a disease.

11. The method as recited in claim 8, wherein predicting an outcome measure includes predicting a life expectancy.

12. The method as recited in claim 8, wherein predicting an outcome measure includes predicting a patient recovery time.

13. The method as recited in claim 8, wherein predicting an outcome measure includes providing statistical probabilities of a plurality of outcomes based upon similar patient models.

14. The method as recited in claim 8, wherein aligning similar patients includes computing a dynamic time-warping distance from an event in a timeline of a query patient to a history of a similar patient to provide a longitudinal alignment.

15. The method as recited in claim 8, wherein combining similarity scores includes weighting the similarity scores.

16. The method as recited in claim 15, wherein weighting is based on physician input on a case-by-case basis.

17. A computer readable storage medium comprising a computer readable program for long term patient prognosis, wherein the computer readable program when executed on a computer causes the computer to perform the steps of:
constructing similarity functions from a plurality of data sources stored in physical memory;
combining similarity scores into an overall similarity score between patients;
aligning at least one similar patient based on a time dimension; and
predicting an outcome measure of a query patient based on the at least one similar patient.

18. The computer readable storage medium as recited in claim 17, wherein predicting the outcome measure includes predicting a new outcome measure by changing conditions used to predict the outcome measure.

19. The computer readable storage medium as recited in claim 17, wherein predicting an outcome measure includes predicting a progression of a disease.

20. The computer readable storage medium as recited in claim 17, wherein predicting an outcome measure includes predicting a life expectancy.

21. The computer readable storage medium as recited in claim 17, wherein predicting an outcome measure includes predicting a patient recovery time.

22. The computer readable storage medium as recited in claim 17, wherein predicting an outcome measure includes providing statistical probabilities of a plurality of outcomes based upon similar patient models.

23. The computer readable storage medium as recited in claim 17, wherein aligning similar patients includes computing a dynamic time-warping distance from an event in a timeline of a query patient to a history of a similar patient to provide a longitudinal alignment.

24. The computer readable storage medium as recited in claim 17, wherein combining similarity scores includes weighting the similarity scores.

25. The computer readable storage medium as recited in claim 24, wherein weighting is based on physician input on a case-by-case basis.
